(19) United States
(12) Patent Application Publication
(10) Pub. No.: US 2016/0161071 A1
(43) Pub. Date: Jun. 9, 2016

(54) Solar-Powered Flameless Candle

(71) Applicant: Winvic Sales Inc., Markham (CA)

(72) Inventor: Paul Jean, Delson (CA)

(21) Appl. No.: 14/839,578

(22) Filed: Aug. 28, 2015

Related U.S. Application Data
(60) Provisional application No. 62/086,764, filed on Dec. 3, 2014.

(51) Int. Cl. F21S 9/03; F21S 10/02; F21S 10/04; F21S 6/00

(52) U.S. Cl. CPC F21S 9/037; F21S 6/001; F21S 10/023; F21S 10/043; F21W 2121/00

(57) ABSTRACT

A flameless candle may comprise an electronic circuit and a candle shell substantially enclosing a light-receiving face of at least one photovoltaic cell. An electronic circuit may comprise the at least one photovoltaic cell, at least one light source, and at least one electrochemical cell. The candle shell may comprise a translucent material. A substantial fraction of light originating from locations external to the candle shell may not directly strike the light-receiving face of the photovoltaic cell. The candle shell may fully enclose the light-receiving face of the photovoltaic cell.

### CROSS-REFERENCE TO RELATED APPLICATIONS

This application claims benefit of priority from U.S. Provisional Patent Application No. 62/086,764, filed Dec. 3, 2014, which is hereby incorporated by reference in its entirety herein.

### FIELD

The present disclosure relates generally to solar-powered flameless candles.

### BACKGROUND

Flameless candles are an electronic alternative to conventional candles. Flameless candles generally comprise a candle shell, a light source (such as a small light bulb or a light emitting diode (LED)), and a power source. Unlike conventional candles, the power source in flameless candles may include one or more electrochemical cells, such as those found in single use or rechargeable AA and AAA batteries. Alternatively, flameless candles may be powered by solar power via one or more photovoltaic cells.

### SUMMARY

The present disclosure relates generally to flameless candles in which at least one photovoltaic cell is at least partially enclosed by a candle shell.

A flameless candle may comprise a circuit, which may itself comprise at least one light source, at least one electrochemical cell , and at least one photovoltaic cell including a light-receiving face. The at least one electrochemical cell may be in electrical communication with the at least one light source. The at least one photovoltaic cell may be in electrical communication with the at least one electrochemical cell. A flameless candle may further comprise a candle shell substantially enclosing the light-receiving face of the at least one photovoltaic cell. Optionally, the candle shell may comprise a translucent material. Optionally, substantially all light originating from locations external to the candle shell may not directly strike the light-receiving face of the at least one photovoltaic cell.

Optionally, the candle shell may fully enclose the light-receiving face of the at least one photovoltaic cell. Optionally, the translucent material may comprise wax. Optionally, the at least one electrochemical cell may be rechargeable. Optionally the at least one light source may be controlled to intermittently illuminate to provide a flame-like flickering effect. Optionally, the at least one light source comprises a first light source and a second light source. Optionally, the first light source may be controlled to intermittently illuminate to provide a flame-like flickering effect. Optionally, the second light source may be controlled to change colors. Optionally, the candle shell may have an interior with an upper region, within which the at least one light source may be located. Optionally, the light-receiving face of the at least one photovoltaic cell may be located in a lower region of the interior of the candle shell. The upper region may be at least partially separated from a lower region of the interior of the candle shell by a light shield. Optionally, the light shield may comprise the at least one photovoltaic cell. The candle shell may optionally substantially enclose the at least one light source or not enclose at least a portion of the at least one light source.

Optionally, the at least one light source may comprise a first light source located in an upper region of the interior of the candle shell and a second light source located in the lower region of the interior of the candle shell. The first light source may be controlled to intermittently illuminate to provide a flame-like flickering effect. The second light source may be controlled to change colors.

Optionally, the at least one photovoltaic cell may comprise a curved, circular, or toroid shape. Optionally, the flameless candle may further comprise a riser extending from a base of the flameless candle into the interior of the candle shell. The at least one photovoltaic cell may extend around the riser.

Additional features and advantages of the present disclosure will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF SEVERAL VIEWS OF THE DRAWINGS

The following is a description of the figures in the accompanying drawings. The figures are not necessarily to scale, and certain features and certain views of the figures may be shown exaggerated in scale or in schematic in the interest of clarity or conciseness.

FIG. 1 is a perspective view of a flameless candle with a candle shell removed from the rest of the flameless candle.

FIG. 2 is an elevational cross-sectional schematic view of a flameless candle, additionally showing an external light emitter.

FIG. 3 is a schematic perspective view of a flameless candle.

FIG. 4 is a schematic perspective view of a flameless candle.

FIG. 5 is a schematic perspective view of a flameless candle.

FIG. 6 is a schematic perspective view of a flameless candle.

FIG. 7 is a schematic perspective view of a flameless candle.

FIG. 8 is a schematic perspective view of a flameless candle.

FIG. 9 is a schematic perspective view of a flameless candle.

The following reference characters are used in this specification:
1 Candle shell
2 Electronic circuit board
3 Photovoltaic cell
4 Light source
5 Raised platform
6 Electrochemical cell
7 External light emitter
8 Photons
9 Flameless candle
10 Riser
11 Base

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, numerous specific details may be set forth in order to provide a thorough understanding of embodiments of the present invention. However, it will be clear to one skilled in the art when embodiments of the present invention may be practiced without some or all of these specific details. In other instances, well-known features or processes may not be described in detail so as not to unnecessarily obscure the invention. In addition, like or identical reference numerals may be used to identify common or similar elements.

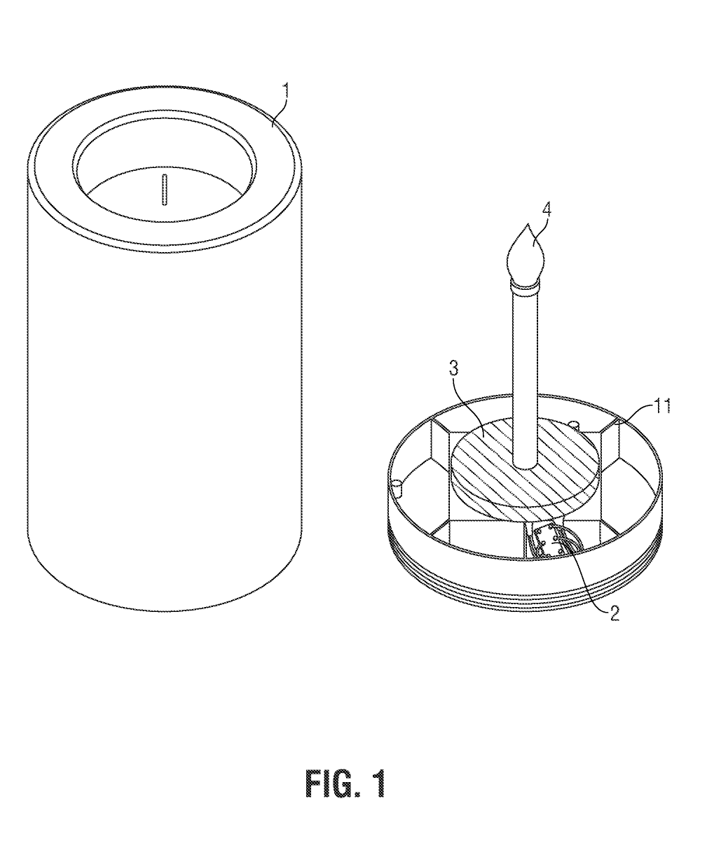

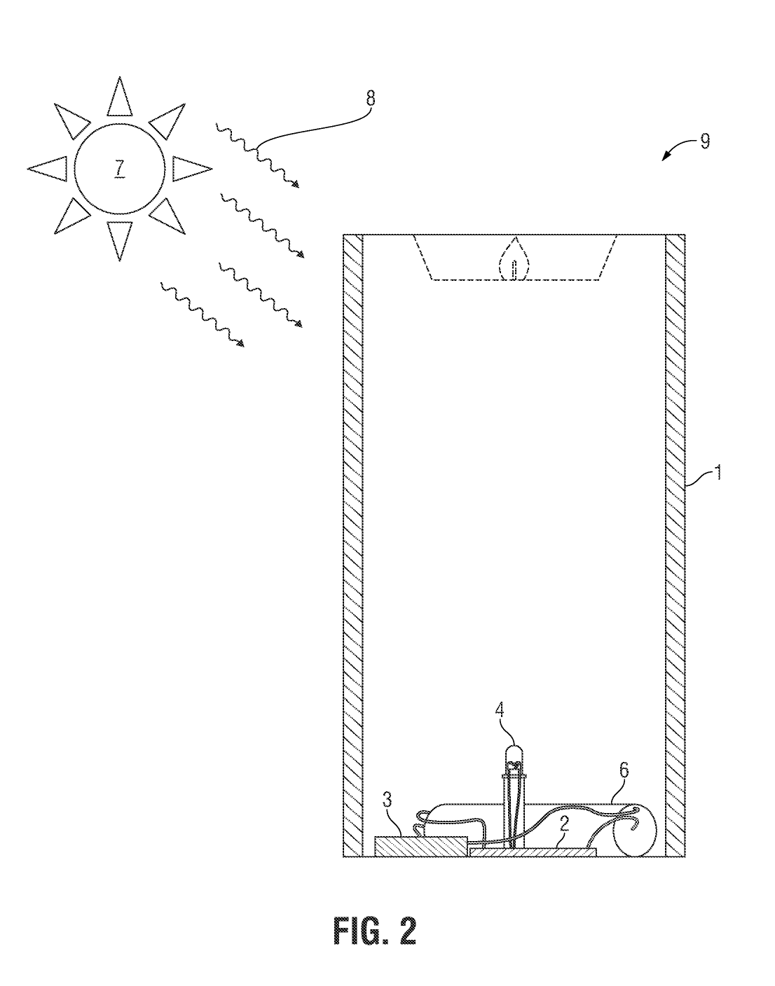

FIGS. 1-9 illustrate a flameless candle 9 of the present disclosure. As shown in, for example, FIG. 2, a flameless candle 9 may comprise a candle shell 1, at least one photovoltaic cell 3, at least one light source 4 (e.g., a light emitting diode (LED) or a small light bulb), and at least one electrochemical cell 6. An electronic circuit may be formed comprising the at least one photovoltaic cell 3, the at least one light source 4, and the at least one electrochemical cell 6. The electronic circuit may optionally further comprise an electronic circuit board 2.

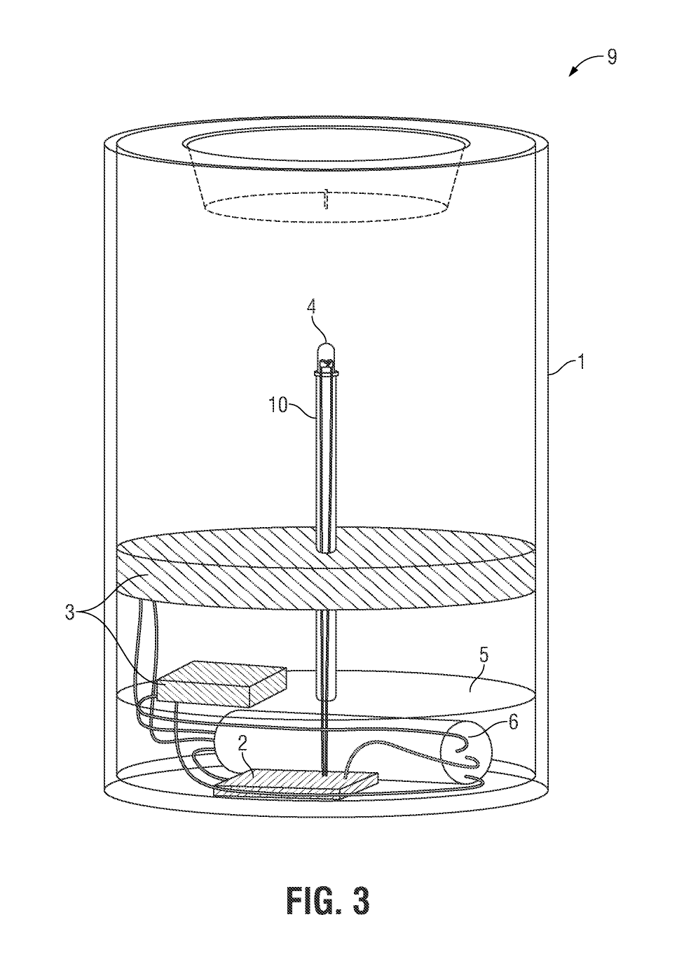

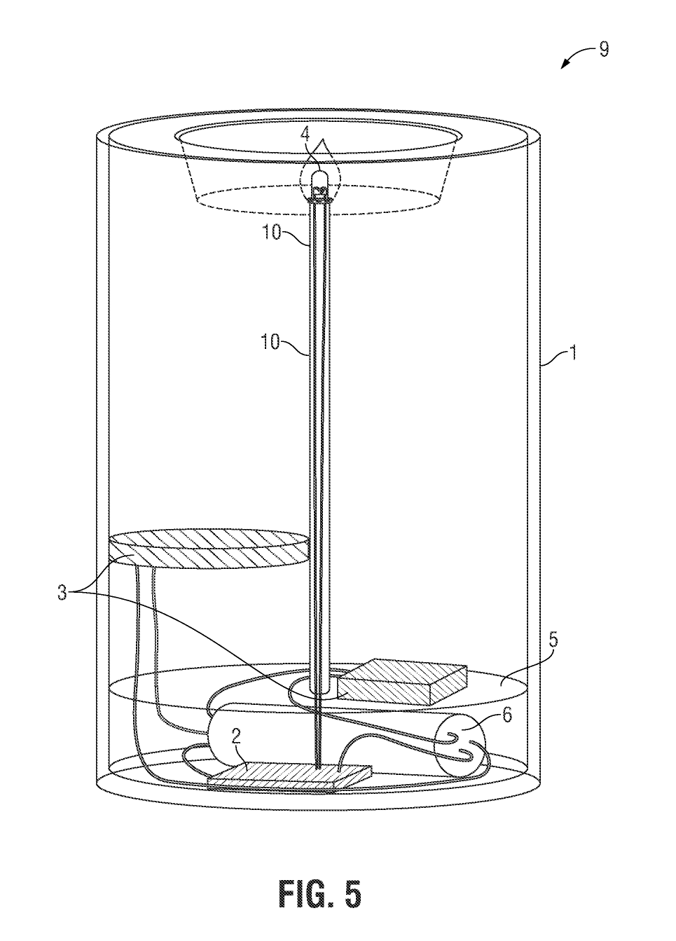

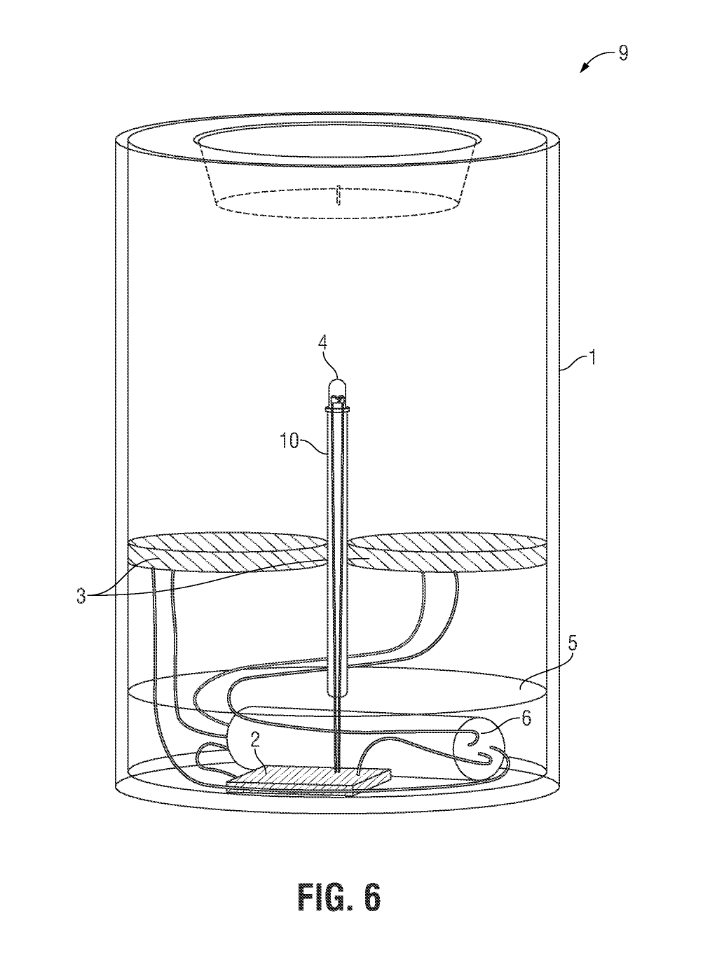

The photovoltaic cell 3 may comprise a light-receiving face. The photovoltaic cell 3 may optionally be monocrystal, polycrystal, or amorphous. A monocrystal photovoltaic cell 3 may be preferred when the surface area of the photovoltaic cell 3 is smaller. An amorphous or polycrystal photovoltaic cell 3 may be preferred when the surface area of the photovoltaic cell 3 is larger. Optionally, a photovoltaic cell 3 may have a shape that is square/rectangular/cuboid (for example, as shown in FIGS. 3, 5, and 8) curved (for example, as shown in FIGS. 1, and 3-7), circular/cylindrical (for example, as shown in FIGS. 5 and 6), conical, or toroid (for example, as shown in FIGS. 1, 3, 4, and 7). The flameless candle 9 may comprise more than one photovoltaic cell 3, with each photovoltaic cell 3 optionally having the same shape (for example, as shown in FIG. 6) or different shapes (for example, as shown in FIG. 3). Each photovoltaic cell 3 may lay flat (for example, flat with respect to the plane of the raised platform 5), or may be at an angle (for example, at an angle of 30 or 45 degrees with respect to the plane of the raised platform 5)

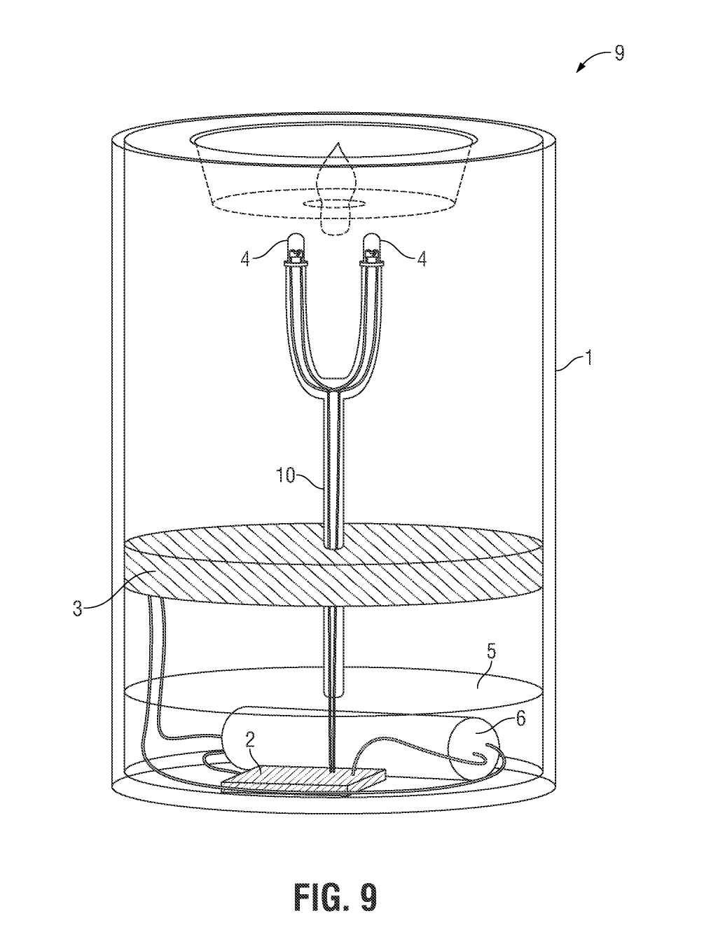

Optionally, the light source 4 (which may comprise multiple light sources, as shown in FIG. 9) may generate one or more different colors of light, such as white, yellow, orange, or red light, and such light may optionally be generated constantly or, to provide a flickering effect, intermittently. The light source 4 may optionally generate changing colors of light. Optionally, one color-changing light source 4 may be used in conjunction with one flickering light source 4. To provide a realistic flame effect, the color-changing light source 4 may be located below the flickering light source 4. When more than one light source 4 is used, the colors of each light source may be the same (e.g., yellow) or different (e.g., yellow and orange). As shown in FIG. 9, a pair of light sources 4,4 may be used in conjunction to illuminate (for example, through a hole at the top of the candle shell 1) a flame-shaped outline to create a realistic flame effect. The flame-shaped outline, shown in, for example, FIG. 9, may be static or moveable with respect to other portions of the flameless candle 9.

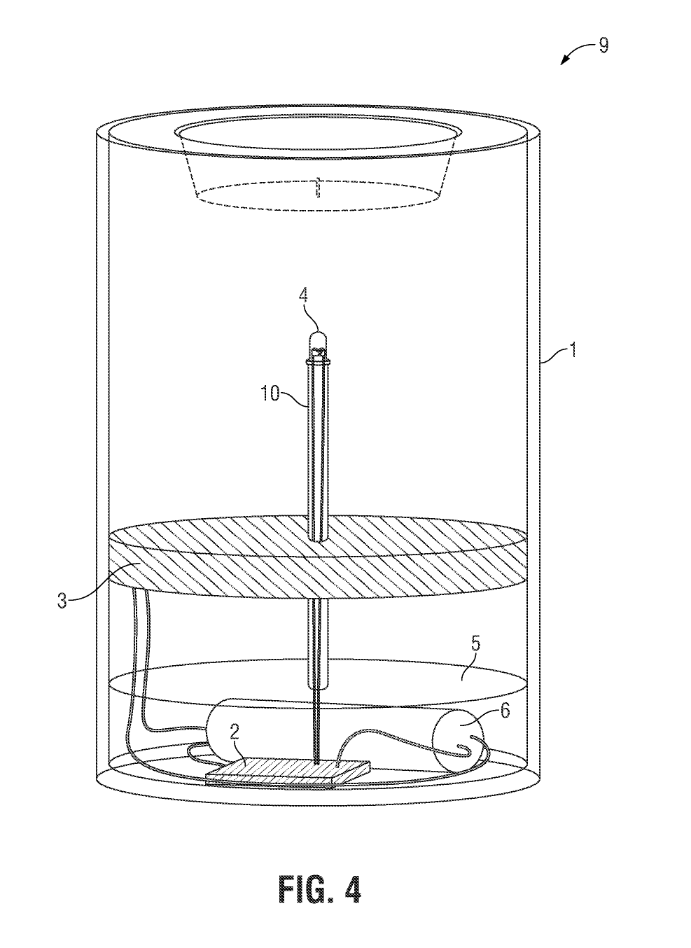

Optionally, the candle shell 1 may comprise a translucent material, such as wax, high density polyethylene (HDPE), or low density polyethylene (LDPE). As shown in, for example, FIG. 4, the candle shell 1 may optionally substantially enclose the light source 4. Alternatively, as shown in FIG. 5, the candle shell 1 may optionally not enclose at least a portion of the light source 4.

The light source 4 may optionally be located in an upper region of the interior of the candle shell 1. Optionally, the light source 4 may be mounted on a riser 10. As shown in, for example, FIG.4, the photovoltaic cell 3 may optionally extend around a riser 10. The electrochemical cell 6 may optionally be a rechargeable battery (such as a battery comprising nickel cadmium, nickel-metal hydride, lead acid, lithium ion, lithium ion polymer, or reusable alkaline).

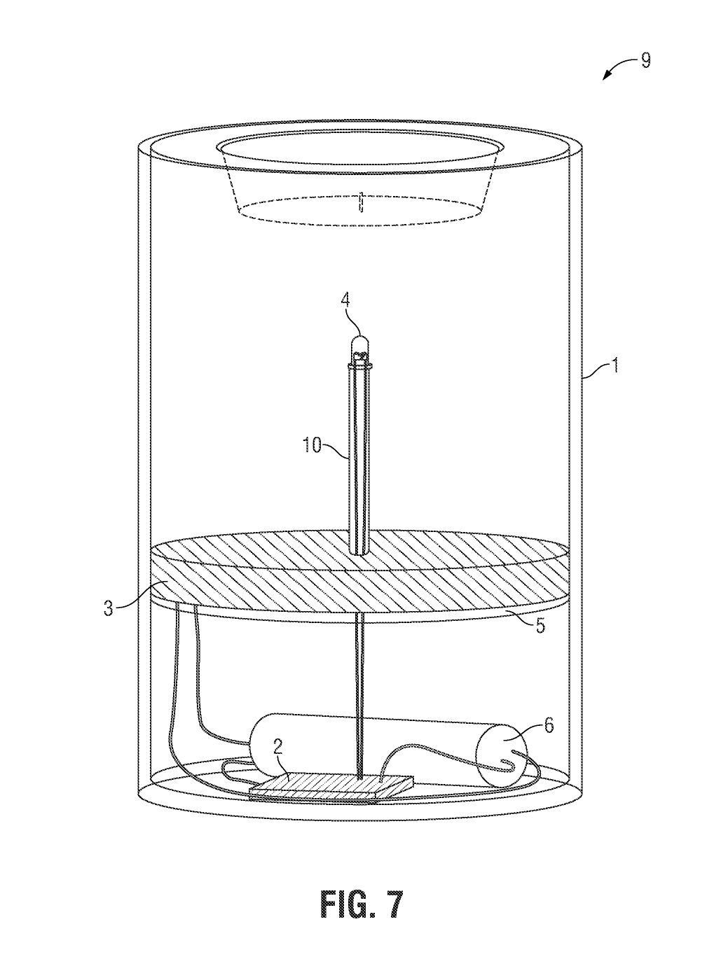

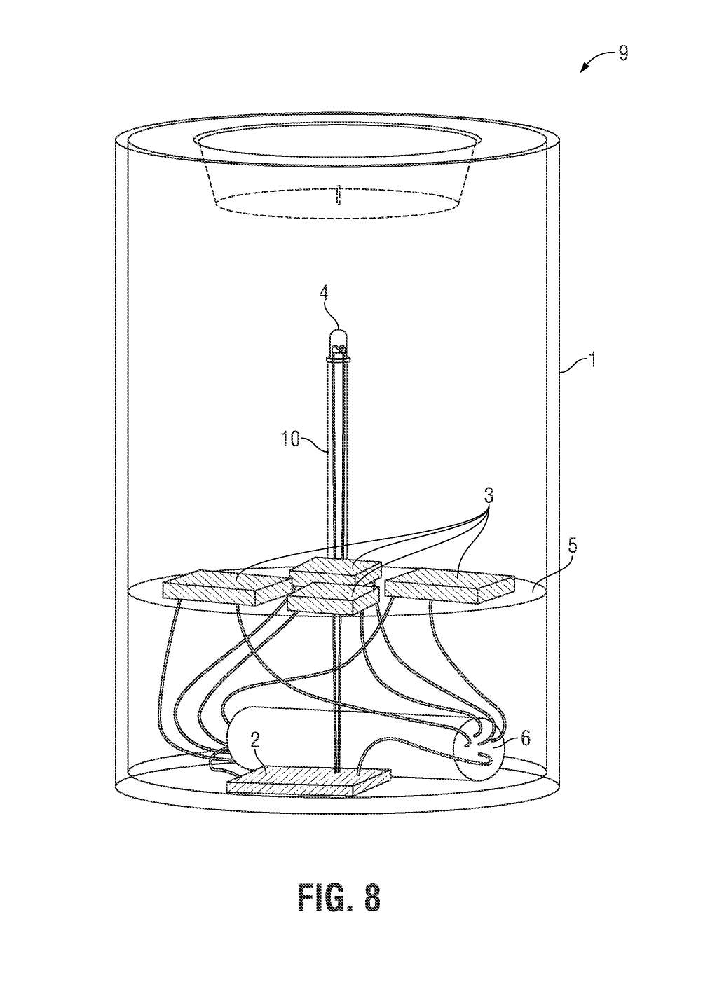

As shown in, for example, FIG. 3, the flameless candle 9 may further comprise a raised platform 5. The raised platform 5 may have an area equivalent to, or less than, an entire horizontal cross-section of the candle shell 1. As shown in FIGS. 7 and 8, one or more photovoltaic cells 3 may optionally be mounted on the raised platform 5. As shown in FIGS. 7 and 8, the light-receiving face of the one or more photovoltaic cells 3 may be enclosed within an upper region within the interior of the candle shell 1. The raised platform 5 may at least partially separate the upper region of the interior of a candle shell 1 from a lower region of the candle shell 1. The lower region of the candle shell 1 may be located between the raised platform 5 and a base 11 of the flameless candle 9. Optionally, as shown in FIG. 1, the electronic circuit board 2 and the electrochemical cell 6 may be stored in the lower region. By partially or completely separating the upper region from the lower region, the raised platform 5 acts as a light shield. The light source 4 may optionally be located in the upper region. Optionally, one color-changing light source 4 may be used in conjunction with one flickering light source 4. To provide a realistic flame effect, the flickering light source 4 may be located in the upper region and the color-changing light source 4 may be located in the lower region. The raised platform 5, as a light shield, may partially or completely block light emitted from the light source 4 from entering the lower region, which may promote a realistic illusion of a conventional candle.

FIG. 2 illustrates photons 8 generated by an external light emitter 7. Optionally, the external light emitter 7 may be the Sun. Optionally, a substantial fraction of photons 8 will not directly strike the surface of the photovoltaic cell 3, but will instead first pass through the candle shell 9. Optionally, even where there is a gap in the candle shell 1 (for example, around the riser 10) that allows some photons 8 to pass directly into an interior of the candle shell 1, substantially all of the photons 8 generated by the external light emitter 7 will not directly strike the surface of the photovoltaic cell 3. The photons 8 may diffuse through the candle shell 9. Using multiple photovoltaic cells 3 may enhance the rate at which a rechargeable electrochemical cell 6 is recharged, and reduce the need to orient the flameless candle 9 at a particular angle or orientation relative to the external light emitter 7.

Optionally, the flameless candle 9 may comprise more than one electrochemical cell 6. Optionally, the flameless candle 9 may comprise a first electrochemical cell 6 that may be rechargeable and a second electrochemical cell 6 that may not be rechargeable. The flameless candle 9 may optionally comprise a switch allowing a user to select a power source. For example, such a switch may allow a user to select between no power source (power off), a rechargeable electrochemical cell 6, and a non-rechargeable electrochemical cell 6. Optionally, the flameless candle 9 may further comprise a timer that causes, after an elapsed period of time, a change in power source. For example, after four hours a timer may cause the flameless candle 9 to change the power source from a rechargeable electrochemical cell 6 to no power source (power off). Alternatively, for example, after six hours a timer may cause the flameless candle 9 to change the power source from a rechargeable electrochemical cell 6 to a non-rechargeable electrochemical cell 6.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A flameless candle comprising:
a circuit comprising:
at least one light source;
at least one electrochemical cell in electrical communication with the at least one light source; and
at least one photovoltaic cell including a light-receiving face, wherein the at least one photovoltaic cell is in electrical communication with the at least one electrochemical cell; and
a candle shell substantially enclosing the light-receiving face of the at least one photovoltaic cell, wherein:
the candle shell comprises a translucent material; and
substantially all light originating from locations external to the candle shell does not directly strike the light-receiving face of the at least one photovoltaic cell.

2. The flameless candle of claim 1, wherein the candle shell fully encloses the light-receiving face of the at least one photovoltaic cell.

3. The flameless candle of claim 1, wherein the translucent material comprises wax.

4. The flameless candle of claim 1, wherein the at least one electrochemical cell is rechargeable.

5. The flameless candle of claim 1, wherein the at least one light source is controlled to intermittently illuminate to provide a flame-like flickering effect.

6. The flameless candle of claim 1, wherein the at least one light source comprises a first light source and a second light source.

7. The flameless candle of claim 6, wherein the first light source is controlled to intermittently illuminate to provide a flame-like flickering effect.

8. The flameless candle of claim 7, wherein the second light source is controlled to change colors.

9. The flameless candle of claim 1, wherein:
the candle shell has an interior; and
the light-receiving face of the at least one photovoltaic cell is located in a lower region of the interior of the candle shell.

10. The flameless candle of claim 1, wherein the candle shell substantially encloses the at least one light source.

11. The flameless candle of claim 1, wherein the candle shell does not enclose at least a portion of the at least one light source.

12. The flameless candle of claim 1, wherein:
the candle shell has an interior; and
the at least one light source is located in an upper region of the interior of the candle shell.

13. The flameless candle of claim 1, further comprising a light shield located in an interior of the candle shell,
wherein the light shield at least partially separates a lower region of the interior of the candle shell from an upper region of the interior of the candle shell.

14. The flameless candle of claim 13, wherein:
the at least one light source comprises a first light source and a second light source;
the first light source is located in the upper region of the interior of the candle shell; and
the second light source is located in the lower region of the interior of the candle shell.

15. The flameless candle of claim 14, wherein the first light source is controlled to intermittently illuminate to provide a flame-like flickering effect.

16. The flameless candle of claim 15, wherein the second light source is controlled to change colors.

17. The flameless candle of claim 13, wherein the light shield comprises the at least one photovoltaic cell.

18. The flameless candle of claim 1, wherein the at least one photovoltaic cell comprises a curved shape.

19. The flameless candle of claim 18, wherein the at least one photovoltaic cell comprises a circular shape.

20. The flameless candle of claim 19, wherein the at least one photovoltaic cell comprises a toroid shape.

21. The flameless candle of claim 1, wherein:
a riser extends from a base of the flameless candle into the interior of the candle shell; and
the at least one photovoltaic cell extends around the riser.
